(19) United States
(12) Patent Application Publication
(10) Pub. No.: US 2020/0039770 A1
(43) Pub. Date: Feb. 6, 2020

(54) FEEDER MODULE

(71) Applicant: Kinpo Electronics, Inc., New Taipei City (TW)

(72) Inventors: Shih-His Chiang, New Taipei City (TW); Hung-Huan Sung, New Taipei City (TW)

(73) Assignee: Kinpo Electronics, Inc., New Taipei City (TW)

(21) Appl. No.: 16/150,279

(22) Filed: Oct. 3, 2018

(30) Foreign Application Priority Data
Aug. 1, 2018 (CN) 201810862258.0

(51) Int. Cl. B65H 5/06; H04N 1/00

(52) U.S. Cl. CPC B65H 5/06; H04N 1/0057; B65H 2402/44; B65H 2801/06; B65H 2553/41; B65H 2403/40; B65H 2511/12; B65H 2511/11; B65H 2801/39

(57) ABSTRACT

A feeder module for a multi-function product including a tray having a first axial direction and a second axial direction, at least two first sensors disposed at the tray in the second axial direction, a clamping member movably assembled to the tray in the second axial direction, and a control unit is provided. A document placed on the tray is driven to move into the multi-function product in the first axial direction. The clamping member has at least two shielding pieces moving in the second axial direction. The first sensors located on moving paths of the shielding pieces generate different sensing states according to whether the first sensors being shielded by the shielding pieces or not. A control unit electrically connected to the first sensors determines a width of the document according to the sensing states of the at least two first sensors.

### CROSS REFERENCE TO RELATED APPLICATION

This application claims the priority benefit of China application serial no. 201810862258.0, filed on Aug. 1, 2018. The entirety of the above-mentioned patent application is hereby incorporated by reference herein and made a part of specification.

### BACKGROUND

### Technical Field

The disclosure relates to a feeder module suited for a multi-function product.

### Description of Related Art

Generally, in multi-function products (MFP) providing the paper feeding function, sizes of paper can not be identified by the multi-function products most of the time. That is, in an existing auto feeder module (Auto Document Feeder, ADF), the largest size of paper is used as the basis for data transmission actually.

Nevertheless, as variety of sizes of paper grows, if the largest size of paper is still used to act as the basis, the processing time is evidently wasted, so that processing efficiency is lowered.

Accordingly, how a multi-function product can more effectively sense the sizes of paper through a proper structure and element arrangement so that the multi-function product can obtain the sizes of paper in advance, so as to perform data transmission based on the corresponding sizes to enhance processing efficiency is an important issue in this field.

### SUMMARY

The disclosure provides a feeder module of a multi-function product capable of identifying a size specification of a document after the document being placed at the feeder module.

According to an embodiment of the disclosure, the feeder module is suitable for a multi-function product. The feeder module includes a tray, at least two first sensors, a clamping member, and a control unit. The tray has a first axial direction and a second axial direction. A document is suitable for being placed on the tray and is driven by the feeder module to move into the multi-function product in the first axial direction. The at least two first sensors are disposed at the tray in the second axial direction. The clamping member is movably assembled to the tray in the second axial direction. The clamping member has at least two shielding pieces moving in the second axial direction along with the clamping member. The at least two first sensors are located on moving paths of the at least two shielding pieces, and the at least two first sensors generate different sensing states according to whether the first sensors being shielded by the shielding pieces or not. A control unit is electrically connected to the at least two first sensors. The control unit determines a width of the document according to the sensing states of the at least two first sensors. The width of the document is parallel to the second axial direction.

To sum up, the feeder module identifies the size specification of the document placed at the tray through the at least two first sensors and the clamping member disposed in the second axial direction. That is, the clamping member has at least two shielding pieces moving in the second axial direction along with the clamping member. The at least two first sensors are located on the moving paths of the at least two shielding pieces so as to be shielded or not through the at least two shielding pieces, such that the at least two first sensors generate different sensing states. In this way, the control unit can determine the width of the document through the sensing states of the at least two first sensors. The width is parallel to the second axial direction. Therefore, before the multi-function product processes the document, that is, after the document is clamped by the clamping member, the multi-function product can obtain the size specification of the document. In this way, the multi-function product can accordingly perform processing corresponding to the required data volume, and that processing efficiency of the multi-function product can be effectively increased.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view of a multi-function product.

FIG. 2 is a diagram illustrating electrical connection relations of part of members of the multi-function product.

FIG. 3A is a top view of a feeder module.

FIG. 3B is a schematic three-dimensional view of the feeder module.

FIG. 3C is a schematic perspective view of the feeder module.

FIG. 4 is a schematic perspective view of another document and a feeder module.

FIG. 5 is a lookup table of size specifications of the documents and sensors.

FIG. 6A to FIG. 6C are schematic perspective views of different types of the document and the feeder module.

FIG. 7 is a lookup table of size specifications of the documents and sensors according to another embodiment of the disclosure.

### DESCRIPTION OF THE EMBODIMENTS

Descriptions of the disclosure are given with reference to the exemplary embodiments illustrated by the accompanying drawings. Wherever possible, the same reference numbers are used in the drawings and the description to refer to the same or like parts.

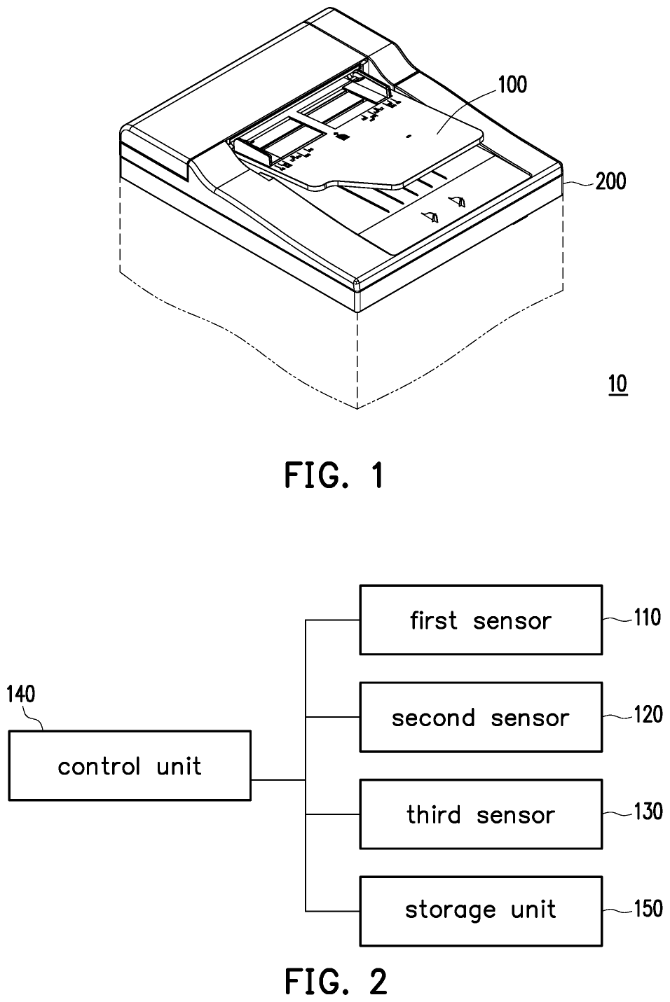

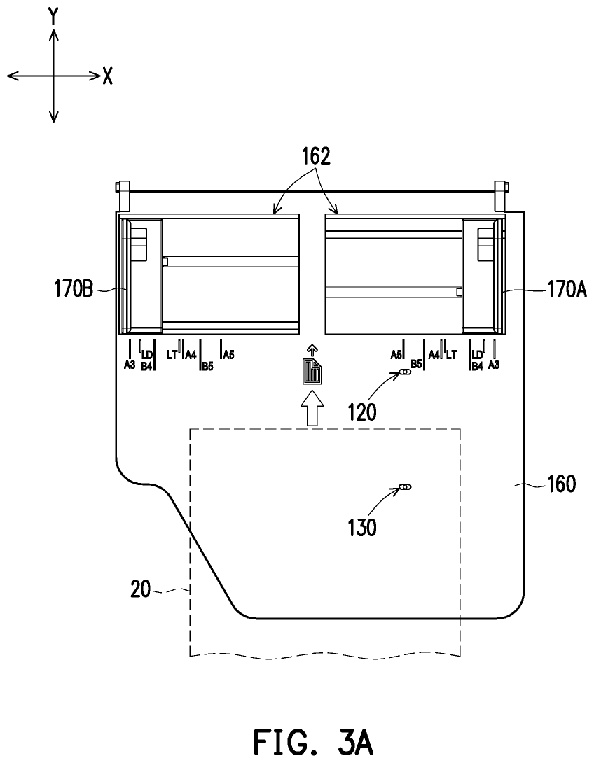

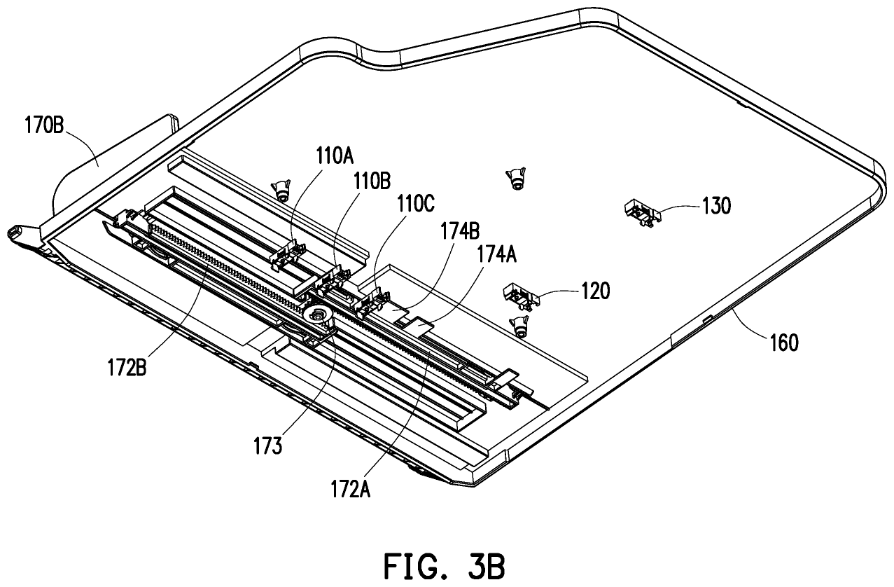

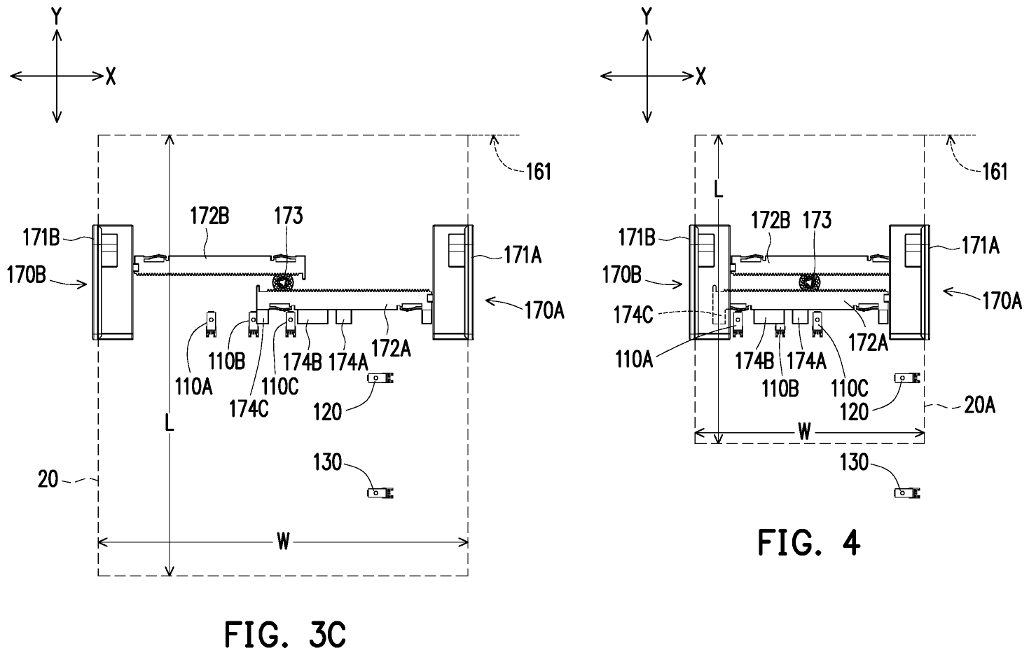

FIG. 1 is a schematic view of a multi-function product. FIG. 2 is a diagram illustrating electrical connection relations of part of members of the multi-function product. FIG. 3A is a top view of a feeder module. With reference to FIG. 1, FIG. 2, and FIG. 3A together, in this embodiment, a multi-function product/printer/peripheral (MFP) 10 is a known automatic office apparatus which incorporates multiple functions, such as copying, faxing, scanning, printing, etc. The multi-function product 10 includes a machine base 200 and a feeder module 100 disposed thereon. A document 20 (i.e. a paper) is suitable for being placed on a tray 160 of the feeder module 100. The tray 160 has a first axial direction Y and a second axial direction X. The document 20 is driven by the feeder module 100 (e.g., a pickup roller, not shown) to move into the multi-function product 10 in the first axial direction Y and is processed by a processing module (not shown) disposed in the multi-function product 10. Descriptions of the multi-function product 10 which is not provided herein and hereinafter can be obtained through the related art and thus are not provided hereinafter.

Further, the feeder module 100 further includes three first sensors 110, a control unit 140, a storage unit 150, a clamping member 170A, and a clamping member 170B. The control unit 140 is electrically connected to the first sensors 110 and the storage unit 150. The storage unit 150 is configured to store a lookup table including corresponding relations between size specifications of the documents and sensing states of the first sensors 110. The clamping member 170A and the clamping member 170B are movably assembled to a track 162 of the tray 160 in the second axial direction X, and the clamping member 170A and the clamping member 170B are symmetrically disposed with respect to the first axial direction Y. After the document 20 is placed on the tray 160, a user applies a force on the clamping member 170A and the clamping member 170B, so that the document 20 is clamped and aligned through the clamping member 170A and the clamping member 170B. That is, a width W of the document 20 is clamped between the clamping member 170A and the clamping member 170B. At this time, the control unit 140 may obtain a size specification corresponding to the document 20 through the lookup table based on the sensing states of the first sensors 110. In other words, when the document 20 is placed at the tray 160, if the control unit 140 obtains the size specification of the document 20 before the document 20 moves into the multi-function product 10 for being processed, processing efficiency of the multi-function product 10 on the document 20 can be enhanced. Herein, the first axial direction Y is orthogonal to the second axial direction X. Generally, in the feeder modules included in scanners, multi-function products, printers, etc. The two axial directions X and Y are designed to be orthogonal to each other.

FIG. 3B is a schematic three-dimensional view of the feeder module. FIG. 3C is a schematic perspective view of the feeder module which illustrate a corresponding relation between the document 20 and the feeder module 100. With reference to FIG. 3A to FIG. 3C together, specifically, in addition to the tray 160 described above, the feeder module 100 of this embodiment substantially includes three first sensors (namely a first sensor 110A, a first sensor 110B, and a first sensor 110C), a second sensor 120, and a third sensor 130. The clamping member 170A includes a clamping portion 171A and an extending portion 172A, and the clamping member 170B includes a clamping portion 171B and an extending portion 172B. A transmission gear 173 is included between the clamping member 170A and the clamping member 170B. The clamping portion 171A and the clamping portion 171B protrude from the tray 160 and are configured to clamp the document 20 on the tray 160. The extending portion 172A and the extending portion 172B respectively extend opposite to each other from the clamping portion 171A and the clamping portion 171B and have rack structures, as such, the transmission gear 173 may be rotatably coupled between the rack structures of the extending portion 172A and the extending portion 172B. In this way, when the user applies a force to one clamping portion such as the clamping portion 171A (or the clamping portion 171B), the other clamping portion such as the clamping portion 171B (or the clamping portion 171A) is driven simultaneously. That is, the clamping member 170A and the clamping member 170B may simultaneously move on the tray 160 opposite to each other through such structure. Herein, a length L of the document 20 is parallel to the first axial direction Y, and the width W of the document 20 is parallel to the second axial direction X.

Note that one clamping member (the clamping member 170A is taken as an example herein) has at least three shielding pieces (three shielding pieces, namely a shielding piece 174A, a shielding piece 174B, and a shielding piece 174C, are taken as an example herein) respectively extending from the extending portion 172A in the first axial direction Y. The three shielding pieces 174A, 174B, and 174C are arranged in the second axial direction X. Further, the extending portion 172A, the shielding piece 174A, the shielding piece 174B, and the shielding piece 174C are located between the tray 160 and the first sensor 110A, the first sensor 110B, and the first sensor 110C. At the same time, the first sensor 110A, the first sensor 110B, and the first sensor 110C are also located on moving paths of the shielding piece 174A, the shielding piece 174B, and the shielding piece 174C. In this way, after the document 20 is paced on the tray 160, the user applies a force on one of the clamping member 170A and the clamping member 170B, so that the document 20 is clamped and aligned between the clamping portion 171A and the clamping portion 171B. Corresponding to a size of the document 20, corresponding relationships are formed between locations and movements of the shielding piece 174A, the shielding piece 174B, and the shielding piece 174C and the first sensor 110A, the first sensor 110B, and the first sensor 110C. That is, the first sensor 110A, the first sensor 110B, and the first sensor 110C generate different sensing states according to whether the first sensor 110A, the first sensor 110B, and the first sensor 110C are shielded by the shielding piece 174A, the shielding piece 174B, and the shielding piece 174C.

Note that each of the first sensor 110A, the first sensor 110B, and the first sensor 110C is, for example, a light sensor and accordingly generates a first signal and a second signal through sensing changes in light. Herein, the first signal is defined to be generated after the sensor senses reflected light (i.e., a shielding object exists in front of the sensor) and is labeled as “1” in the following, and the second signal is defined to be generated after the sensor senses no reflected light (i.e., no shielding object exists in front of the sensor) and is labeled as “0” in the following. Accordingly, the control unit 140 may refer to the lookup table in the storage unit 150 through the sensing states of the first sensor 110A, the first sensor 110B, and the first sensor 110C and obtains the size specification of the document 20 at the tray 160 at the moment. Herein, the 2 types of signals generated by the 3 first sensors may be applied to 8 different combinations (2³=8).

For instance, FIG. 4 is a schematic perspective view of another document and a feeder module. With reference to FIG. 3C and FIG. 4 together, in FIG. 3C, the document 20 illustrated, for example, features an A3 specification (297 mm×420 mm) and is placed on the tray 160 in a short edge feed (SEF) manner. That is, the width W is 297 mm, and the length L is 420 mm (regarded as an A3 SEF specification herein). After the document 20 is clamped and aligned between the clamping portion 171A and the clamping portion 171B, the first sensor 110A, the first sensor 110B, and the first sensor 110C are not shielded by the shielding piece 174A, the shielding piece 174B, and the shielding piece 174C at this time. Hence, the first sensor 110A, the first sensor 110B, and the first sensor 110C all generate the second signals, that is, a signal combination of “0, 0, 0” is formed.

In addition, with reference to FIG. 4, a document 20A illustrated, for example, features a B5 specification (182 mm×257 mm) and is placed on the tray 160 in the short edge feed (SEF) manner. That is, the width W is 182 mm, and the length L is 257 mm (regarded as a B5 SEF specification herein). After the document 20A is clamped and aligned between the clamping portion 171A and the clamping portion 171B, only the first sensor 110B is shielded by the shielding piece 110B, and the remaining two first sensors, namely the first sensor 110A and the first sensor 110C, are not shielded. Hence, the signal combination generated by the first sensor 110A, the first sensor 110B, and the first sensor 110C is “0, 1, 0”.

It can be seen from FIG. 3C and FIG. 4 that when the size specification of the document changes and when the document is placed differently, clamping of the document through the clamping member 170A and the clamping member 170B changes as well. In this way, through the corresponding relationships between the first sensor 110A, the first sensor 110B, and the first sensor 110C and the shielding piece 174A, the shielding piece 174B, and the shielding piece 174C, different signal combinations are formed by the first sensor 110A, the first sensor 110B, and the first sensor 110C. The control unit 140 can accordingly refer to the lookup table and determines the width W of the document. Note that after being placed at the tray 160, the document 20 is aligned with a baseline 161 at a feeding end in the first axial direction Y, that is, the baseline 161 is a reference of the length L to be determined for the document 20.

Further, note that if the multi-function product 10 is intended to process 8 different paper widths, 8 first sensors corresponding to the different widths can naturally be disposed at the feeder module, so that the width of a document can thereby by identified through determining whether the document shields the 8 first sensors. Note that if the shielding piece 174A, the shielding piece 174B, and the shielding piece 174C in this embodiment are not provided and only the first sensors are used to directly sense movement of a document, it is less likely to identify the size specification with fewer first sensors and a sufficient number of the first sensors are needed because the document presents an undisrupted surface in the width W direction (the second axial direction X), as such, the first sensors can not generate sufficient sensing combinations. For instance, taking the three first sensors described above for example, that is, the first sensor 110A, the first sensor 110B, and the first sensor 110C, if the shielding piece 174A, the shielding piece 174B, and the shielding piece 174C are omitted, only 4 types of combinations can be generated. That is, only 4 paper widths W can be obtained because only the signal combinations “0, 0, 0”, “1, 0, 0”, “1, 1, 0”, and “1, 1, 1” are provided, and other signal combinations such as the signal combination of “0, 1, 0” are not to be generated.

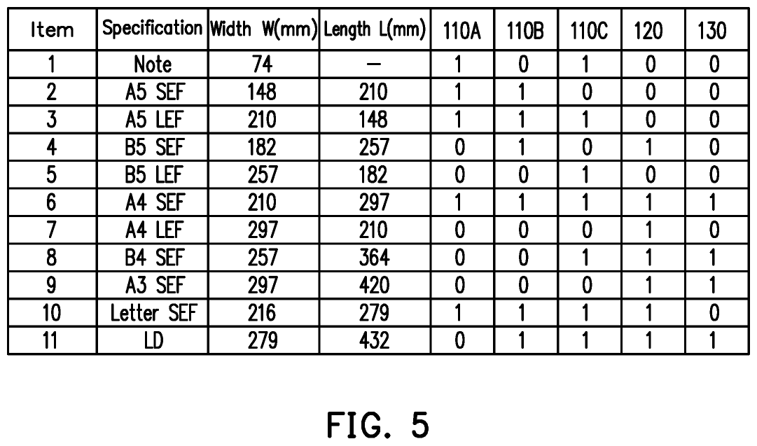

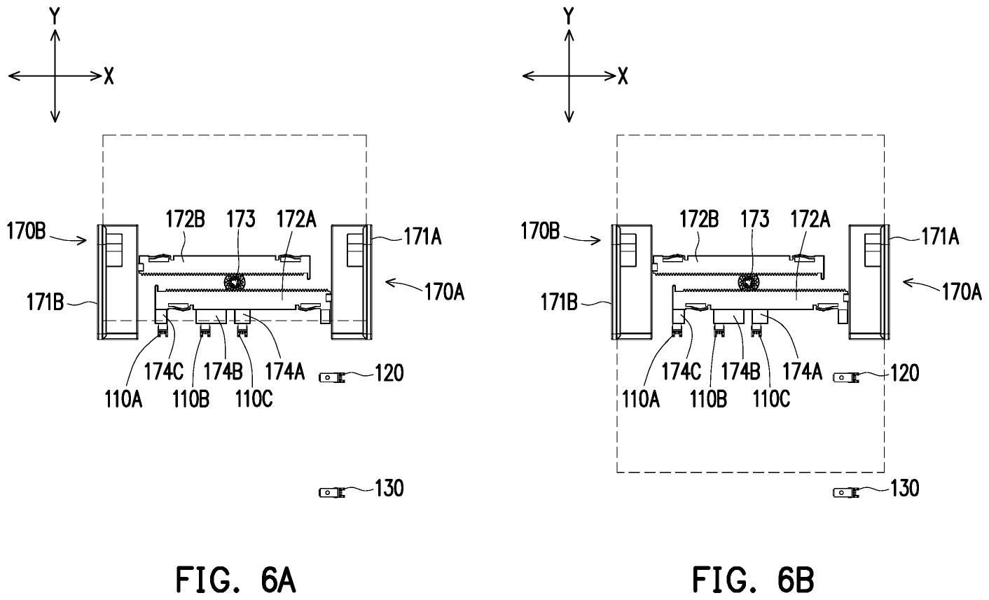

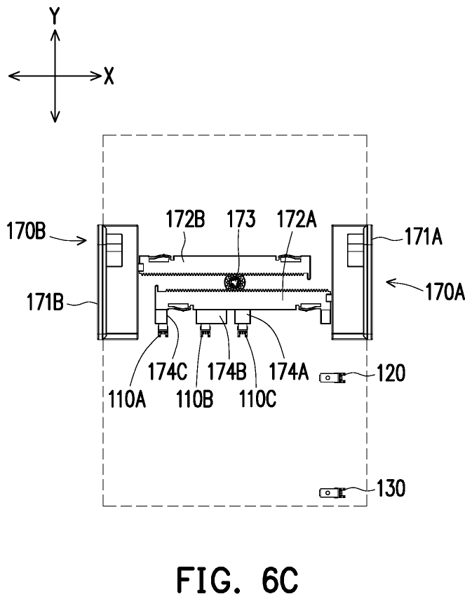

FIG. 5 is a lookup table of size specifications of the documents and sensors. FIG. 6A to FIG. 6C are schematic perspective views of different types of document and the feeder module. With reference to FIG. 5, FIG. 6A, and FIG. 6C, the lookup table in FIG. 5 is related information stored in the storage unit 150 in advance. The size specifications adopted by this embodiment include a Note (form paper) specification, an A5 SEF specification, an A5 LEF specification, a B5 SEF specification, a B5 LEF specification, an A4 SEF specification, an A4 LEF specification, a B4 SEF specification, an A3 SEF specification, a Letter (letter paper) SEF specification, and a LD (labels) specification. 8 different combinations can be generated according to the sensing states of the first sensor 110A, the first sensor 110B, and the first sensor 110C. Nevertheless, it may also be seen that when size specifications of the documents increase but the number of the first sensors does not correspondingly increase, a same signal is generated for the document of certain size specifications. For instance, when a document of the A5 LEF specification is placed in a long edge feed (LEF) manner (e.g., FIG. 6A), a document of the A4 SEF specification is placed in the short edge feed (SEF) manner (e.g., FIG. 6B), and a document of the Letter specification is placed in the short edge feed (SEF) manner (e.g., FIG. 6C), the signal combinations generated by the first sensor 110A, the first sensor 110B, and the first sensor 110C are “1, 1, 1” respectively.

Therefore, the second sensor 120 and the third sensor 130 arranged on the tray 160 in the first axial direction Y are further adopted in this embodiment to sense the length L of the document. In this way, more signal combinations of the sensing states are generated in combination with sensing of the width W of the document described above.

Taking FIG. 6A to FIG. 6C for example, the second sensor 120 and the third sensor 130 sequentially generate different signal combinations, that is, the signal combination of “0,0” is generated in FIG. 6A, the signal combination of “1, 0” is generated in FIG. 6B, and the signal combination of “1, 1” is generated in FIG. 6C. Hence, the signal combinations of the first sensors 110A-110C, the second sensor 120 and the third sensor 130 can be evidently distinguished from the signal combination of “1, 1, 1” generated by the first sensor 110A, the first sensor 110B, and the first sensor 110C.

As described above, the first sensor 110A, the first sensor 110B, the first sensor 110C, the second sensor 120, and the third sensor 130 are all light sensors, and each of the first sensor 110A, the first sensor 110B, the first sensor 110C, the second sensor 120, and the third sensor 130 generates the first signal (the signal “1”) and the second signal (the signal “0”) through sensing changes in light. In this way, the size specifications of the documents in the storage unit 150 may include variation combinations of the first signals and the second signals. Certainly, when the number of the size specifications of the documents decreases, content of the lookup table may correspondingly be adjusted appropriately.

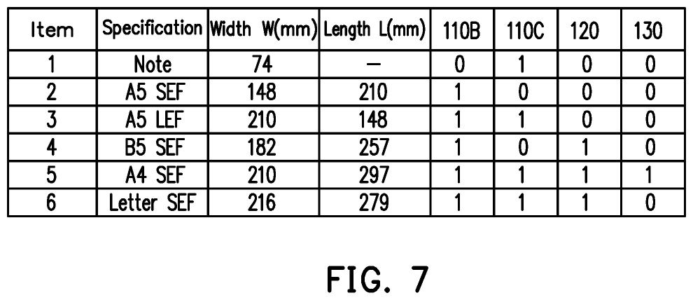

FIG. 7 is a lookup table of size specifications of the documents and sensors according to another embodiment of the disclosure. Two first sensors, that is, a first sensor 110B and a first sensor 110C, are taken for example, and 6 types of signal combinations are generated when the second sensor 120 and the third sensor 130 are combined. That is, six types of the size specifications of the documents can be identified, including the Note specification, the A5 SEF specification, the A5 LEF specification, the B5 SEF specification, the A4 SEF specification, and the Letter SEF specification. It thus can be seen from the embodiment of FIG. 5 and FIG. 7 that at least two first sensors 110 are disposed in the direction of the width W of the document in the disclosure, so as to work together with the second sensor 120 and the third sensor 130 disposed in the direction of the length L of the document. In this way, at least six types of the size specifications (paper types) can be identified.

In addition, after obtaining the size specification (the paper type) of the required document, a designer may thereby obtain the numbers and positions of the disposed at least two first sensors, the second sensor, and the third sensor through reverse thinking based on the foregoing embodiments.

In view of the foregoing, the feeder module identifies the size specification of the document placed at the tray through the at least three first sensors disposed in the second axial direction. The control unit refers to the lookup table in the storage unit based on the sensing states of the first sensors. The lookup table includes the corresponding relationships between the size specifications of the document and the sensing states of the first sensors. In this way, when the paper is placed on the tray, the size specification of the document is accordingly obtained. That is, the multi-function product obtains the size specification of the document before processing the document, as such, processing efficiency of the multi-function product is effectively increased.

Further, through combining the second sensor and the third sensor disposed in the first axial direction with the sensing states of the first sensors, the feeder module is able to generate more arrangement combinations and is suitable for being used for more size specifications.

Finally, it is worth noting that the foregoing embodiments are merely described to illustrate the technical means of the disclosure and should not be construed as limitations of the disclosure. Even though the foregoing embodiments are referenced to provide detailed description of the disclosure, people having ordinary skill in the art should understand that various modifications and variations can be made to the technical means in the disclosed embodiments, or equivalent replacements may be made for part or all of the technical features; nevertheless, it is intended that the modifications, variations, and replacements shall not make the nature of the technical means to depart from the scope of the technical means of the embodiments of the disclosure.

1. A feeder module, suited for a multi-function product, wherein the feeder module comprises:
a tray, having a first axial direction and a second axial direction, a document being placed on the tray and driven by the feeder module to move into the multi-function product in the first axial direction, a width of the document being parallel to the second axial direction;
three first sensors, disposed at the tray in the second axial direction;
a clamping member, having three shielding pieces, the clamping member movably assembled to the tray in the second axial direction, the clamping member having at least two shielding pieces configured to move in the second axial direction along with the clamping member, the three first sensors being located on moving paths of the at least two shielding pieces, the three first sensors generating different sensing states according to whether the three first sensors being shielded by the at least two shielding pieces or not;
a control unit, electrically connected to the three first sensors,
a second sensor and a third sensor, disposed at the tray in the first axial direction, the control unit being electrically connected to the second sensor and the third sensor, the second sensor and the third sensor generating different sensing states according to whether the second sensor and the third sensor being shielded by the document or not; and
a storage unit, configured to store a lookup table, the lookup table comprising corresponding relationships between size specifications of the documents and the sensing states of the three first sensors, the second sensor, and the third sensor, the control unit being electrically connected to the storage unit, the control unit referring to the lookup table according to the sensing states of the three first sensors, the second sensor, and the third sensor so as to determine the size specification of the document,
after the document being placed on the tray and the clamping member moving in the second axial direction to clamp the document, the control unit determining the width of the document according to the sensing states of the three first sensors,
wherein the size specifications of the documents comprise a Note specification, an A5 SEF specification, an A5 LEF specification, a B5 SEF specification, a B5 LEF specification, an A4 SEF specification, an A4 LEF specification, a B4 SEF specification, an A3 SEF specification, a Letter SEF specification, and a LD specification.

2-4. (canceled)

5. The feeder module as claimed in claim 1, wherein the feeder module comprises a pair of clamping members movably assembled to the tray in the second axial direction respectively, each of the pair of clamping members has a clamping portion and an extending portion, the clamping portions protrude from the tray, each of the extending portions extends from one of the clamping portions towards the other one of the clamping portion, the at least two shielding pieces extend from the extending portions, and the extending portions and the at least two shielding pieces are located between the tray and the three first sensors.

6. The feeder module as claimed in claim 5, wherein each of the extending portions has a rack structure, and the feeder module further comprises:
a transmission gear, rotatably coupled between the rack structures.

7. The feeder module as claimed in claim 5, wherein the at least two shielding pieces are located at one of the pair of the clamping members.

8-9. (canceled)

10. The feeder module as claimed in claim 1, wherein the three first sensors, the second sensor, and the third sensor are light sensors, and each of the three first sensors, the second sensor, and the third sensor generates a first signal and a second signal through sensing changes in light, the size specifications of the documents in the storage unit comprise variation combinations of the first signals and the second signals.
